(19) United States
(12) Patent Application Publication
(10) Pub. No.: US 2018/0283991 A1
(43) Pub. Date: Oct. 4, 2018

(54) EXPERIMENTAL SIMULATION PROCESS, FOR OBTAINING INFORMATION RELATIVE TO THE RELIABILITY OF AN AUTOMATIC PASSENGER ACCESS DOOR

(71) Applicant: ALSTOM Transport Technologies, SAINT OUEN (FR)

(72) Inventors: Quentin THEVENET, PARIS (FR); Frédéric SETAN, SEPMERIES (FR); Laurent VAGNER, COURBEVOIE (FR)

(21) Appl. No.: 15/937,378

(22) Filed: Mar. 27, 2018

(30) Foreign Application Priority Data
Mar. 29, 2017 (FR) 1752620

(51) Int. Cl. G01M 17/08; B61D 19/02; G05B 23/02

(52) U.S. Cl. CPC G01M 17/08; G05B 23/0283; B61D 19/026

(57) ABSTRACT

Disclosed is an experimental simulation method for obtaining information relative to the reliability of an automatic passenger access door for a railway vehicle, including: a) fixing a non-downgraded and nominally adjusted door prototype, including a frame, a casement and an actuator driving the casement, on a test bench; b) subjecting the prototype to a series of tests; c) measuring, throughout the tests, signals characteristic of the performance of the door; and d) reiterating a) to c) with a downgraded door prototype at several downgrade levels. Step b) includes altering at least one of the context elements from among the orientation of the prototype around a first axis corresponding to the gradient, the orientation of the prototype around a second axis corresponding to the incline, the deformation of the frame and/or the casement, the line voltage of the door system, the weather conditions, or the presence of a door closure obstacle.

The present invention relates to an experimental simulation process, for obtaining information relative to the reliability of an automatic passenger access door. The invention is applicable in the railway field, and in particular for rolling stock.

The simulation is done on a door prototype comprising a frame, a casement and an actuator driving the casement. The casement is made up of two sliding leaves.

Reducing the costs of maintenance operations, failures during use and downtime are three major areas for improvement in the railway industry. Passenger access doors make up a significant portion of the potential areas for improvement because they form systems used directly by travelers and because there are many of them on a vehicle like a train, the maintenance costs and reliability then being even more affected. This is why it is crucial to ensure that they work properly. In particular, the goal is to improve their robustness and reliability.

In this field, WO 01/34446 A1 discloses a method enabling smart planning of maintenance operations to be done on an automatic door of a railway vehicle. This method more particularly aims to determine when it is necessary to perform a maintenance operation on the door, and thus to avoid any unnecessary procedures and failures during commercial use. The method consists of measuring, in real time, the consumption values of the door actuating system, as well as the closing/opening speed values of the door, and comparing these values with experimental data established beforehand. In particular, this data is recorded during simulations done on a test bench under normal conditions and under downgraded conditions. By comparing the experimental data with the real model, it is then possible to determine the state of wear of the door and, if applicable, to plan a maintenance operation before any malfunction appears.

WO 01/34446 A1 says nothing about how the simulations are done on the test bench, for either normal or downgraded conditions.

The invention intends to propose a more specific method, making it possible to test a traveler access door prototype in more depth, and therefore so that it more closely matches reality.

To that end, the invention relates to an experimental simulation process, for obtaining information relative to the reliability of an automatic passenger access door for a railway vehicle, this method comprising steps consisting of:
a) fixing a door prototype, without damage and nominally adjusted, on a test bench, the prototype comprising a frame, a casement and an actuator driving the casement,
b) subjecting the prototype to a series of tests,
c) measuring, throughout the entire series of tests, characteristic signals of the performance levels of the door,
d) reiterating steps a) to c) with a downgraded door prototype with several downgrading levels.

According to the invention, step b) consists of modifying at least one of the following context elements:
the orientation of the prototype around a first axis corresponding to the gradient,
the orientation of the prototype around a second axis corresponding to the incline,
deforming the frame and/or the casement,
the line voltage of the door system,
the weather conditions,
the presence of an obstacle to the closure of the door.

The idea at the base of the invention is therefore to test the passenger access door under real conditions on a test bench, by analyzing the effects related to the context elements and the effects related to downgraded performance levels of the access system. In particular, a door prototype is subjected both to downgrades and context variations, in particular severe, so as to clearly identify the causes of a malfunction, anticipate it and calculate the corresponding error margins. This makes it possible to implement a predictive maintenance system, optimized based on test results.

According to advantageous but optional aspects of the invention, such a method may incorporate one or more of the following features, considered in any technically allowable combination:
In step d), the downgraded door prototype is obtained by replacing at least one component of the non-downgraded and nominally adjusted prototype with a downgraded component.
In step d), the downgraded door prototype is obtained by displacing one or several mechanical links.
In step d), the downgraded door prototype is obtained by opposing resistance forces, such as friction.
The method comprises an additional step consisting of analyzing the measurements done with the non-downgraded and nominally adjusted prototype and with the downgraded door prototype, so as to identify the influence of the downgrades of the door on the operation of the door upon opening and closing.
The tests carried out in step b) are organized according to an experimental plan.
The order of the experiments is optimized to minimize the adjustment times between each experiment.
The characteristic signals include at least one signal representative of the position of the casement.
The characteristic signals include at least one signal representative of the speed of the casement.
The characteristic signals include at least one signal representative of the energy consumed by the actuator.
The characteristic signals include at least one signal representative of the vibration level during certain characteristic operating phases and in a particular location.

The invention and other advantages thereof will appear more clearly in light of the following description of one embodiment of an experimental simulation method according to its principle, provided solely as an example and done in reference to the appended drawings, in which:

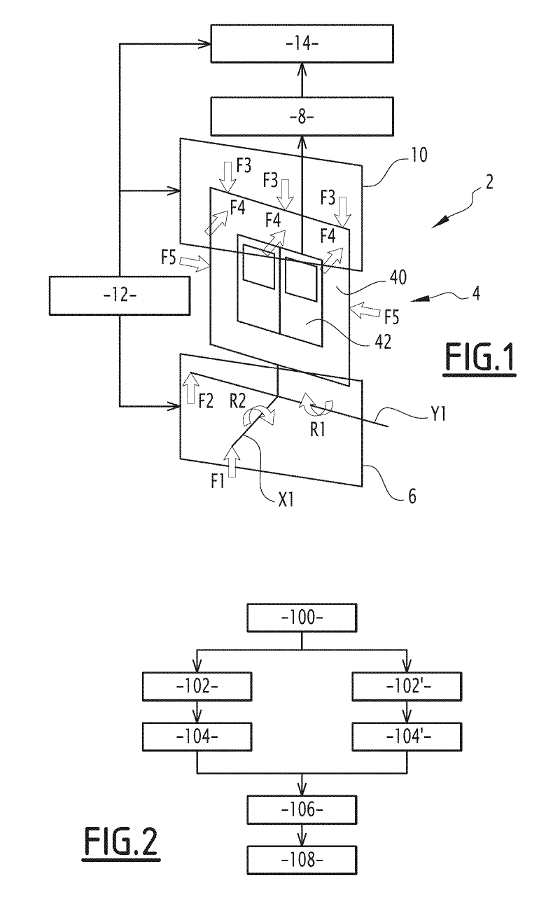

FIG. 1 is a block diagram of a test bench for carrying out an experimental simulation method according to the invention, and

FIG. 2 is a flowchart of the steps of the method according to the invention.

FIG. 1 shows a test bench 2 for carrying out experimental simulations on a passenger access door prototype 4, i.e., a test specimen. The door prototype 4 is a reproduction of a passenger access door of a railway vehicle, i.e., a vehicle traveling on rails. It involves rolling railway stock (train, tram, subway, etc.).

In the example, the door prototype 4 comprises a frame 40, i.e., a casing, which is a structure representative of the body of the railway vehicle and which corresponds to a replica of a part of the vehicle in which the door is mounted. The prototype 4 also comprises a casement 42. In the example, the casement is formed by two leaves 42 driven in an outer sliding movement. An actuator (not shown) allows the opening and closing of the leaves 42.

The test bench 2 is equipped with means 6 for selectively orienting the prototype 4 around a first axis X1 so as to simulate the behavior of the door when the vehicle is on an incline, and to selectively orient the prototype 4 around a second axis Y1, perpendicular and secant to the first axis X1, so as to simulate the behavior of the door when the vehicle is on a gradient.

Preferably, the means 6 include a first jack, designed to apply a force F1 and thus orient the prototype 4 around the axis Y1, as if there was a gradient (arrow R1), and a second jack, designed to apply a force F2 and thus orient the prototype 4 around the axis X1, as if one had an incline (arrow R2).

The test bench 2 also comprises means 10 for applying forces, and therefore deforming the frame 40 and/or the casement 42. Here this involves placing the frame 40 in a stressed state (shearing and torsion) that may appear under normal operating conditions, for example due to the weight of the passengers. In the example, such deformations can be obtained by first jacks capable of applying vertical forces F3 on the frame 40, second jacks capable of applying forces F4 substantially perpendicular to the door, and one or more third jacks capable of applying one or more lateral forces F5 on the door.

Advantageously, the test bench is equipped with a data acquisition system 8, formed by a set of sensors (not shown). This acquisition system 8 makes it possible to measure, during the tests (or simulations), characteristic signals of the performance levels of the door, and to store (save) these signals.

In the example, these characteristic signals include signals representative of the position of the leaves 42, a signal representative of the speed of the leaves 42 and signals representative of the energy consumed by the actuator during the opening and closing sequences of the door. Nevertheless, it is possible to consider recording other signals.

The experimental simulations are done as follows. The non-downgraded and nominally adjusted door prototype 4 is mounted, during a step 100, on the test bench 2. In a subsequent step 102, certain adjustments can be made to place the prototype 4 in an initial configuration.

Next, in step 104, a series of tests (or experiments) is carried out, during which at least one of the following context elements is altered using means 12:
the orientation of the prototype around the axis X1 corresponding to the gradient,
the orientation of the prototype around the axis X2 corresponding to the incline,
deforming the frame and/or the casement,
the line voltage of the door system,
the weather conditions,
the presence of an obstacle during the opening/closing cycle of the door.

During these tests, the operation of the door, without downgrading, is therefore tested under real conditions. Advantageously, the tests can be organized in the form of an experimental plan. Additionally, the order of the experiments can be optimized to minimize the adjustment times between each experiment.

The signals characteristic of the operation of the door prototype 4 are measured in a step 106.

These tests make it possible to determine the influence of the context elements on the performance of the door, while assessing the variation of the characteristic signals. To that end, an analysis module 14, of the computer type, is used.

Once the tests are complete, the same experiments are done, but in a downgraded mode. These experiments correspond to step 104′ in FIG. 2. To that end, the method comprises a prior step 102′ during which at least one, preferably some components of the non-downgraded and nominally adjusted prototype 4 are replaced by downgraded, i.e., defective components. It is also possible to displace one or several mechanical connections, change the quantity and quality of lubricant in order to simulate downgrades and deviations relative to the nominal adjustment. It is also possible to consider imposing forces resisting the opening and/or closing of the door, such as frictional forces. The non-downgraded and nominally adjusted prototype is then intentionally converted into a prototype that can be described as downgraded. In the example, the “downgrade” of the prototype is done manually by an operator.

These tests make it possible to learn the influence of intentional downgrades on the opening and closing performance of the door. Thus, the test method according to the invention seeks not to test the door prototype until a malfunction occurs (broken part, downgraded mechanical connection, excessive resistant forces, etc.), but to intentionally introduce downgrades to see the influence of these downgrades on the opening and closing performance of the door.

All of the data collected during the tests (with a non-downgraded and nominally adjusted prototype and downgraded prototype) can be used to determine the state of wear of a passenger access door of a railway vehicle, using an acquisition system onboard the vehicle, comparable to the system 8. Like the system 8, the onboard system makes it possible to measure characteristic signals of the performance of the door (position, speed, energy, vibrations, etc.). These signals can be compared, during each opening/closing cycle, to the signals obtained during tests on a test bench, so as to identify a potential future malfunction and prevent that malfunction by planning a maintenance operation.

Owing to this method, it is no longer essential to plan maintenance operations with a fixed frequency, since some were of no real interest, or even pointless. Additionally, the method makes it possible to reduce the number of failures during use and increase the uptime of rolling stock.

The features of the alternatives and embodiment considered above may be combined with one another to create new embodiments of the invention.

1. An experimental simulation process, for obtaining information relative to the reliability of an automatic passenger access door for a railway vehicle, this method comprising steps consisting of:
a) fixing a door prototype, without damage and nominally adjusted, on a test bench, the door prototype comprising a frame, a casement and an actuator driving the casement,
b) subjecting the door prototype to a series of tests,
c) measuring, throughout the entire series of tests, characteristic signals of the performance levels of the door prototype,
d) reiterating steps a) to c) with a downgraded door prototype with several downgrading levels,
wherein step b) consists of modifying at least one of the following context elements:
an orientation of the door prototype around a first axis corresponding to the gradient,
an orientation of the door prototype around a second axis corresponding to the incline,
deforming the frame and/or the casement,
a line voltage of the door prototype,
weather conditions.

2. The process according to claim 1, wherein, in step d), the downgraded door prototype is obtained by replacing at least one component of the non-downgraded and nominally adjusted prototype with a downgraded component.

3. The process according to claim 1, wherein, in step d), the downgraded door prototype is obtained by displacing one or several mechanical links.

4. The process according to claim 1, wherein, in step d), the downgraded door prototype is obtained by opposing resistance forces.

5. The process according to claim 4, wherein opposing resistance forces are friction.

6. The process according to claim 1, wherein the process comprises an additional step consisting of analyzing the measurements done with the non-downgraded and nominally adjusted prototype and with the downgraded door prototype, so as to identify the influence of the downgrades of the door on the operation of the door upon opening and closing.

7. The process according to claim 1, wherein the tests carried out in step b) are organized according to an experimental plan.

8. The process according to the claim 7, wherein the order of the experiments is optimized to minimize the adjustment times between each experiment.

9. The process according to claim 1, wherein the characteristic signals include at least one signal representative of the position of the casement.

10. The process according to claim 1, wherein the characteristic signals include at least one signal representative of the speed of the casement.

11. The process according to claim 1, wherein the characteristic signals include at least one signal representative of the energy consumed by the actuator.

12. The process according to claim 1, wherein the characteristic signals include at least one signal representative of the vibration level during certain characteristic operating phases and in a particular location.

13. The process according to claim 1, wherein step b) consists of further subjecting the door prototype to the presence of an obstacle to the closure of the door.
